(19) United States
(12) Patent Application Publication
(10) Pub. No.: US 2026/0084753 A1
(43) Pub. Date: Mar. 26, 2026

(54) CRASH-ABSORBER STRUCTURE FOR USE IN A MOTOR VEHICLE

(71) Applicant: Volkswagen Aktiengesellschaft, Wolfsburg (DE)

(72) Inventors: Lars GREVE, Ruehen (DE); Tom Karl ELLER, Wolfsburg (DE); Bram Pieter VAN DE WEG, Wolfsburg (DE)

(73) Assignee: Volkswagen Aktiengesellschaft, Wolfsburg (DE)

(21) Appl. No.: 19/410,233

(22) Filed: Dec. 5, 2025

Related U.S. Application Data
(63) Continuation of application No. PCT/EP2024/063463, filed on May 16, 2024.

(30) Foreign Application Priority Data
Jun. 5, 2023 (DE) 10 2023 205 254.7

(51) Int. Cl. B62D 21/15; B62D 29/00

(52) U.S. Cl. CPC B62D 21/157; B62D 29/008

(57) ABSTRACT

A crash-absorber structure for use in a motor vehicle, preferably for use in a side member of a motor vehicle, comprising a deformation body for absorbing impact forces, which deformation body extends along a deformation axis, and can be deformed along the deformation axis. The crash-absorber structure has a length and a material thickness, as well as a first and second opening having a height and a width. The openings are located at the ends of the deformation body. The deformation body is formed as a cast part made of a metal material and has a regular, undulating outer profile formed along the length thereof.

This nonprovisional application is a continuation of International Application No. PCT/EP2024/063463, which was filed on May 16, 2024, and which claims priority to German Patent Application No. 102023205 254.7, which was filed in Germany on June 5, 2023, and which are both herein incorporated by reference.

### BACKGROUND OF THE INVENTION

### Field of the Invention

The present invention relates to a crash-absorber structure for use in a motor vehicle and to a motor vehicle with such a crash-absorber structure.

### Description of the Background Art

Crash-absorber structures for use in a motor vehicle are known from the state of the art. For reasons of weight and for reasons of maximizing the absorption of impact energy, the known crash-absorber structures are usually made of joined metal sheets or extruded metal profiles.

Disadvantageously, sheet metal or extruded profile structures are less suitable in regard to maximum component integration for maximizing a plurality of advantageous functions in a single component.

To solve this problem, crash-absorber structures made of cast components are known from the state of the art, for example, from DE 19858303 B4 (which corresponds to US 6,220,655), EP 1759958 B1 (which corresponds to US 2007/0114804), DE 102020205196 B4, and DE 19931741 B4. These have a high level of component integration and combine a plurality of functions, such as a reduction in assembly costs and assembly time, space saving, weight reduction, and the like.

Disadvantageously, the known crash-absorber structures made of cast components have a lower ductility, which limits the absorption capacity for absorbing the impact energy.

### SUMMARY OF THE INVENTION

It is therefore an object of the present invention to overcome at least partially the above‑described disadvantages of a crash-absorber structure for a motor vehicle. In particular, it is an object of the present invention to provide a crash-absorber structure for a motor vehicle which has a high level of component integration, is particularly easy and inexpensive to produce in terms of design, and at the same time has a low weight and guarantees a high absorption capacity for impact energy.

In this regard, features and details that are described in relation to the crash-absorber structure of the invention naturally also apply in relation to the motor vehicle of the invention and conversely, so that with respect to the disclosure, reference is or can always be made mutually to the individual aspects of the invention.

According to an example of the invention, a crash-absorber structure is provided for use in a motor vehicle, preferably for use in a side member of a motor vehicle. In this regard, the crash‑absorber structure of the invention comprises a deformation body for absorbing impact forces, which deformation body extends along a deformation axis, can be deformed along the deformation axis, has a length and a material thickness, as well as a first and a second opening having a height and a width, which openings are located at the ends of the deformation body, wherein the deformation body is formed as a cast part made of a metal material and has a regular, undulating outer profile formed along the length thereof.

According to the invention, the crash-absorber structure, in particular due to its design as a cast component with an undulating outer profile formed along its length, is thus designed to enable a high absorption capacity for impact forces and at the same time a high component integration for simple and cost-effective production, as well as low weight. The high absorption capacity for impact forces is ensured in particular by the fact that the undulating outer profile of the deformation body supports a continuous formation of local bending modes. Thus, the undulating outer profile of the invention basically provides a "pre-bending," which ensures that only moderate plastic strains occur in the bending zones in the event of deformation due to the absorption of impact forces and thus also only locally limited cracks occur on the surfaces, under tensile load, of the crash-absorber structure. The resulting folds interlock and jam into each other with further deformation and thus prevent a disruptive sliding of the deformed areas, which ultimately leads to a progressively continuing deformation behavior at a constant level.

The crash-absorber structure of the invention can preferably be disposed in the front and/or rear area, in particular in a side member of a motor vehicle. It is understood that the crash-absorber structure of the invention can be used not only in motor vehicles, such as passenger cars or trucks, but also in commercial vehicles or the like. In the context of the invention, a deformation axis can preferably be understood as an axis along which the crash-absorber structure in question deforms most easily or preferably under load. In the context of the invention, a deformation body can be understood in particular as a body that deforms under load, in particular due to external impact forces with the absorption of impact energy. In the context of the invention, a regular, undulating outer profile can be understood in particular as an outer undulating profile with a uniform amplitude and wavelength, which is preferably arranged symmetrically around a center line. In accordance with the uniform design and symmetrical arrangement, the deformation body in question is preferably subdivided along its length and along the deformation axis into a series of identically formed deformation chambers. With regard to a particularly high deformability along a deformation axis and with regard to simple and cost-effective production of a crash-absorber structure, it can advantageously be provided according to the invention that the deformation body also has a regular, undulating inner profile formed along its length. With regard to a casting-compatible design of the crash-absorber structure in question, the shape of the inner and outer profiles can be formed accordingly identical and the crash-absorber structure preferably has constant wall thicknesses.

With regard to weight optimization and the most complete possible component integration, it can advantageously be provided according to the invention that the deformation body is made of an aluminum material, preferably of an aluminum die casting alloy. With the help of the crash-absorber structure of the invention, it is possible, despite the relatively low ductility of aluminum die casting alloys, to generate a structure that enables a very efficient and robust absorption of the impact energy.

In accordance with the invention, within the context of an improved fastening of the crash-absorber structure in question and an improved force transmission along a deformation axis, it can advantageously be further provided that the deformation body has a first and second end piece, located at the ends, with a straight outer profile. The first and second end piece, located at the ends, can advantageously be designed here in the form of a flange, which in each case preferably comprises a plurality of recesses for the insertion of a fastener, such as screws or the like, and can thus be fastened easily and quickly, for example, to a side member of a motor vehicle.

To ensure a high absorption capacity for impact forces along a deformation axis and at the same time the highest possible component integration, it can advantageously be provided with respect to the subject matter that the deformation body is formed hollow in shape, wherein preferably the first and the second opening are formed circular, wherein the deformation body in particular has a hollow cylindrical basic structure.

With regard to a simple, quick, and material-saving design of a crash-absorber structure of the invention, it can advantageously be provided with respect to the subject matter that the deformation body is formed trough-shaped, wherein preferably the first and the second opening are formed semicircular, wherein the deformation body in particular has a semi-hollow cylindrical basic structure.

With regard to a flexible adaptation to available installation space, it can also be advantageously provided with regard to the subject matter that the deformation body is formed trough-shaped, wherein preferably the first and the second opening are formed U‑shaped, wherein the height of the first and second openings is preferably greater than the width of the first and second openings.

To achieve stabilization of the deformation body along axes other than the deformation axis, it can be further provided with respect to the subject matter that to stabilize the deformation body, stabilizing webs are provided perpendicular to the deformation axis, wherein the stabilizing webs are preferably arranged parallel to the first and second openings. The stabilizing webs are preferably integrated into the cast component in a demoldable manner.

In the context of a robust and stable design of a crash-absorber structure with a high absorption capacity for impact forces along a deformation axis, it can further be provided according to the invention that the deformation body is formed in one piece.

In the context of a simple and rapid production of a robust and stable design of a crash‑absorber structure with a high absorption capacity for impact forces along a deformation axis, it is further conceivable that the deformation body is formed in multiple parts, wherein the deformation body is preferably composed of an upper and an identically formed lower element, wherein the upper and lower elements are each formed in particular semi-hollow cylindrical in shape and are assembled to form a hollow cylindrical deformation body. The upper and lower elements can preferably be joined chemically, mechanically, or thermally, in particular glued, riveted, or welded together.

As an example for an undulating outer profile of a crash-absorber structure with a high absorption capacity for impact forces along a deformation axis, it can additionally be advantageously provided that the regular, undulating outer profile is formed helical in shape. The demolding of the core and outer contour can preferably be carried out via axial de-spindling in a die casting tool.

Likewise, the object of the invention further is a motor vehicle comprising at least one, preferably at least two, crash-absorber structures as described above. Thus, the motor vehicle of the invention provides the same advantages as have already been described in detail with reference to the crash-absorber structure of the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a crash-absorber structure of the invention in a spatial view according to an example;

FIG. 2 is a crash-absorber structure of the invention in a spatial view according to an example;

FIG. 3 is a crash-absorber structure of the invention in a spatial view according to an example;

FIG. 4 is a crash-absorber structure of the invention in a spatial view according to an example;

FIG. 5 is a crash-absorber structure of the invention in a spatial view according to an example;

FIG. 6 is a crash-absorber structure of the invention in a spatial view according to an example;

FIG. 7 is a representation of the energy-absorbing deformation mechanism of the crash-absorber structure of the invention during an impact.

### DETAILED DESCRIPTION

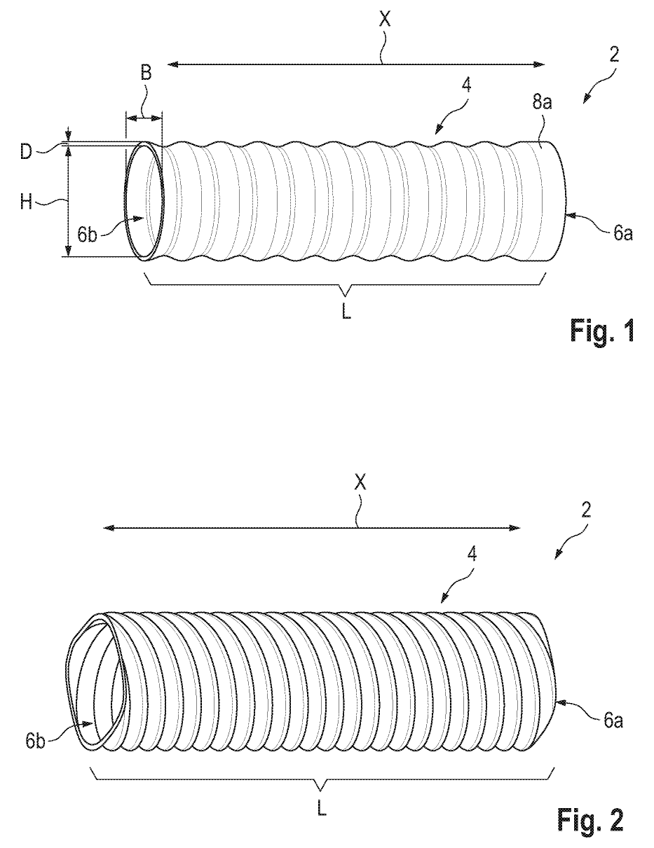

FIG. 1 shows a crash-absorber structure 2 of the invention in a spatial view according to an example.

As can be seen according to FIG. 1, crash-absorber structure 2 comprises a deformation body 4 for absorbing impact forces, which deformation body extends along a deformation axis X, can be deformed along the deformation axis X, has a length L and a material thickness D, as well as a first and a second opening 6a, 6b having a height H and a width B, which openings are located at the ends of deformation body 4, wherein deformation body 4 is formed as a cast part made of a metal material and has a regular, undulating outer profile formed along the length L thereof.

Deformation body 4 can advantageously be made of an aluminum material, in particular of an aluminum die casting alloy.

As can be seen in FIG. 1, deformation body 4 with material thickness D is formed in one piece and comprises a first end piece 8a, located at the end, with a straight outer profile.

It can also be seen that deformation body 4 is formed hollow in shape and that the first and the second opening 6a, 6b are formed circular, so that in the present case deformation body 4 has an at least approximately hollow cylindrical basic structure.

FIG. 2 shows a crash-absorber structure 2 of the invention with an at least approximately hollow cylindrical basic structure in a spatial view according to an example in which the regular, undulating outer profile is formed helical in shape.

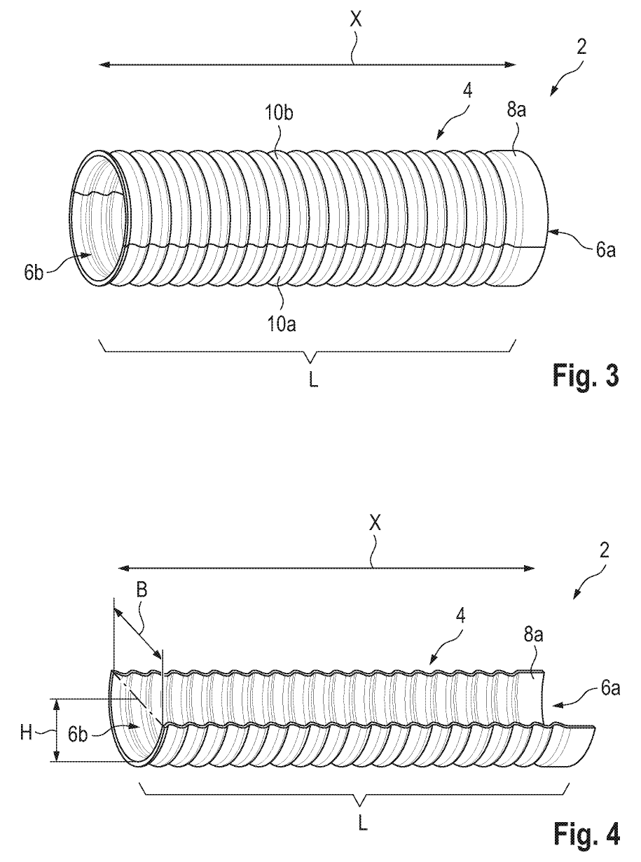

FIG. 3 shows a crash-absorber structure 2 of the invention with an at least approximately hollow cylindrical basic structure in a spatial view according to an example, in which deformation body 4 is formed in multiple parts and is composed of an upper and an identically formed lower element 10a, 10b, wherein the upper and the lower element 10a, 10b are each formed semi-hollow cylindrical in shape and are assembled to form a hollow cylindrical deformation body 4.

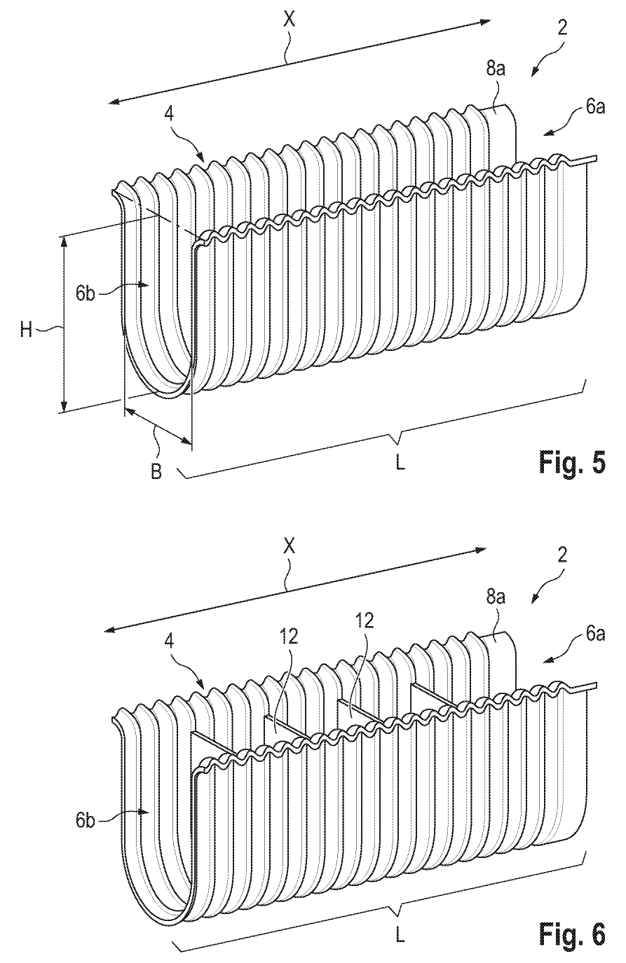

FIG. 4 shows a crash-absorber structure 2 of the invention with an at least approximately semi-hollow cylindrical basic structure in a spatial view according to an example, in which deformation body 4 is formed trough-shaped, wherein preferably the first and the second opening 6a, 6b are formed semicircular in shape and deformation body 4 has a semi-hollow cylindrical basic structure.

FIG. 5 shows a crash-absorber structure 2 of the invention in a spatial view according to an example, in which deformation body 4 is also formed trough-shaped, but the first and the second opening 6a, 6b are formed U-shaped, wherein the height H of the first and second opening 6a, 6b is preferably greater than the width B of the first and second openings 6a, 6b.

FIG. 6 shows a crash-absorber structure 2 of the invention in a spatial view according to an example, which is constructed in the same way as crash-absorber structure 2 according to the prior example, except that to stabilize deformation body 4, stabilizing webs 12 are additionally provided here perpendicular to the deformation axis X and are arranged parallel to the first and second opening 6a, 6b. It is understood that the undulating end pieces 8a shown in FIGS. 5 and 6 can also be formed planar.

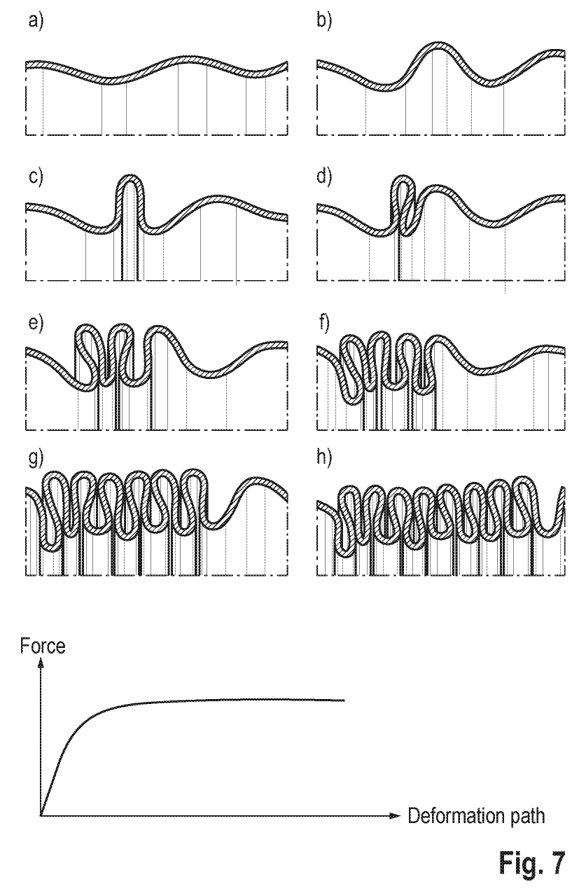

FIG. 7 shows a representation of the energy-absorbing deformation mechanism of crash‑absorber structure 2 of the invention during an impact.

As can be seen in the image sequence from image a to h, the high absorption capacity for impact energy is ensured by crash-absorber structure 2 of the invention, in particular by the fact that a continuous formation of local bending modes is supported by the undulating outer profile of deformation body 4. Thus, the undulating outer profile of the invention effectively provides a "pre-bending" effect, which ensures that only moderate plastic strains occur in the bending zones during deformation due to the absorption of impact forces, and thus also only locally limited cracks form on the surfaces of crash‑absorber structure 2 that are under tensile stress. As can also be seen from the image sequence from image a to h, the resulting folds interlock and jam with further deformation and thus prevent disruptive sliding of the deformed areas, which ultimately leads to a progressively continuing deformation behavior at a constant level, as can be seen from the plot, shown below, of the force versus the deformation path.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A crash-absorber structure for a motor vehicle or for a side member of a motor vehicle, the crash-absorber structure comprising:
a deformation body to absorb impact forces, the deformation body extending along a deformation axis and is adapted to be deformed along the deformation axis, and has a length and a material thickness; and
a first and a second opening having a height and a width, the first and second openings being located at ends of the deformation body,
wherein the deformation body is formed as a cast part made of a metal material and has a regular, undulating outer profile formed along the length thereof.

2. The crash-absorber structure according to claim 1, wherein the deformation body is made of an aluminum material or of an aluminum die casting alloy.

3. The crash-absorber structure according to claim 1, wherein the deformation body has a first and second end piece, located at the ends, with a straight outer profile, and wherein the first and second end piece have a greater material thickness than a rest of the deformation body.

4. The crash-absorber structure according to claim 1, wherein the deformation body is formed hollow in shape, wherein the first and the second opening are formed circular, and wherein the deformation body has a hollow cylindrical basic structure.

5. The crash-absorber structure according to claim 1, wherein the deformation body is formed trough-shaped, wherein the first and the second opening are formed semicircular in shape, and wherein the deformation body has a semi-hollow cylindrical basic structure.

6. The crash-absorber structure according to claim 1, wherein the deformation body is formed trough-shaped, wherein the first and the second opening are formed U-shaped, wherein the height of the first and second opening is greater than the width of the first and second opening.

7. The crash-absorber structure according to claim 1, wherein, to stabilize the deformation body, stabilizing webs are provided substantially perpendicular to the deformation axis, and wherein the stabilizing webs are arranged substantially parallel to the first and second opening.

8. The crash-absorber structure according to claim 1, wherein the deformation body is formed in one piece.

9. The crash-absorber structure according to claim 1, wherein the deformation body is formed in multiple parts, wherein the deformation body has an upper and an identically formed lower element, wherein the upper and the lower element are each formed in a semi-hollow cylindrical shape and are assembled to form a hollow cylindrical deformation body.

10. The crash-absorber structure according to claim 1, wherein the regular, undulating outer profile is formed helical in shape.

11. A motor vehicle, comprising at least one crash-absorber structure according to claim 1.

12. The motor vehicle according to claim 11, wherein the motor vehicle comprises two crash-absorber structures.
